(19) United States
(12) Patent Application Publication
(10) Pub. No.: US 2016/0270393 A1
(43) Pub. Date: Sep. 22, 2016

(54) INSECT REPELLENT COMPOSITIONS AND METHODS OF USE

(71) Applicant: Wageningen Universiteit, Wageningen (NL)

(72) Inventors: Willem TAKKEN, Wageningen (NL); Joseph Johannes Antonius VAN LOON, Bennekom (NL); Laurence J. ZWIEBEL, Nashville, TN (US); Gregory M. PASK, Moreno Valley, CA (US); Wolfgang Richard MUKABANA, Nairobi (KE)

(21) Appl. No.: 15/033,884

(22) PCT Filed: Oct. 30, 2014
(86) PCT No.: PCT/EP2014/073399

§ 371 Date: May 2, 2016

(30) Foreign Application Priority Data
Nov. 4, 2013 (EP) PCT/EP2013/072948

(51) Int. Cl. A01N 43/16; A01M 1/20; A01N 37/18; A01N 25/34; A01N 35/02; A01N 31/02

(52) U.S. Cl. CPC A01N 43/16; A01N 35/02; A01N 31/02; A01N 37/18; A01N 25/34; A01M 1/2027; A01M 1/2038; A01M 1/2061; A01M 2200/01

(57) ABSTRACT

In a bioassay for candidate mosquito repellent compounds, six compounds significantly reduced the number of landings on an attractant-baited pad in a chamber. In order of increasing efficacy the compounds found are 6-methyl-5-hepten-2-one, linalool, delta-decalactone, DEET, PMD and delta-undecalactone. Delta-undecalactone was tested and compared to other repellent compounds in a semi-field experiment. In both “push” and “push-pull” mode, delta-undecalactone provided significant mosquito repelling activity, and improved with respect to catnip and PMD. Delta-decalactone and delta-undecalactone provide improved mosquito repellents with a spatial effect for topical human or animal use, or in environmental control situations in either “push” or “push-pull” mode.

### TECHNICAL FIELD

The invention relates to the field of chemical control of insects, particularly the behavioural control of mosquitoes, i.e. insects of the family Culicidae. More particularly the invention relates to insect repellent compositions and the use of these compositions alone (i.e. “push”) or in conjunction with separate insect attractants (i.e. “pull”), optionally associated with traps or killers to achieve so-called “push-pull” methods of control (see Cook et al. (2007) Annual Review of Entomology 52: 375-400). The invention also relates to devices, apparatus, kits and systems of insect control, whether straightforwardly repelling or push-pull and which employ insect repellent compositions.

### BACKGROUND ART

Mosquito repellents are used around the globe as a protection measure against biting and potentially disease-transmitting mosquitoes and other blood sucking Diptera. Repellents can be applied topically on the skin for personal protection (e.g. the widely used insect repellent N,N-diethyl-meta-toluamide (DEET)), but can also be dispersed spatially to provide a degree of area protection (e.g. the burning of repellent-impregnated coils, candles that contain certain essential oils or even leaves of specific tree species (see Maia and Moore (2011) and references therein).

Another method of diffusing repellent volatiles into an area is by their release from impregnated fabrics (e.g. Ogoma et al. (2012)) such as window screens and bed nets.

Topical and spatial repellents can be used in concert to help in the control of mosquito-borne diseases (see Debboun and Strickman (2012), Killeen and Moore (2012), Achee et al. (2012)). However, existing repellent compositions vary in their degree and longevity of effectiveness. Since its introduction in 1956, DEET continues to set the standard amongst insect repellents for human use.

δ-decalactone (also known as 6-pentyloxan-2-one, δ-Decanolactone, (±)-δ-Pentyl-δ-valerolactone, (±)-5-Decanolide, (±)-6-Pentyltetrahydro-2H-pyran-2-one or 5-Hydroxydecanoic acid δ-lactone) is a compound of the formula:

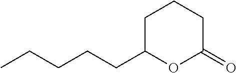

Known for use as a flavouring or fragrance, the compound is found naturally in sherry, white wine, mango, cassava, loganberry and fresh plum. The compound is a colourless liquid at room temperature. The compound is available readily from commercial sources in greater than 98% purity in fine chemical and food grades. The compound has solubility in alcohols or oils.

δ-undecalactone (also known as 6-hexyloxan-2-one or undecanoic δ-lactone) is a compound of the formula:

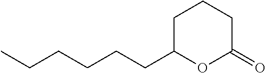

Known for use as a flavouring or fragrance, the compound is found naturally in blackberry, heated butter, milk, coconut and cream. The compound is a colourless liquid at room temperature. The compound is available readily from commercial sources in greater than 97% purity in fine chemical and food grades. The compound has solubility in alcohol.

Insect behaviour is guided by chemical information perceived by olfactory receptors on antennae and mouthparts. Sensitivity studies of the olfactory receptors of An. gambiae s.s. in ex vivo heterologous olfactory receptor (OR) expression assays (Wang et al. 2010) and in vivo electrophysiological studies on antennal olfactory sensilla (Qiu et al. 2006, Carey et al. 2010, Suer 2011) showed certain compounds to affect receptor activity.

Jones P. L. et al (2012) PLoS ONE January 2012, volume 7, pp 1-7 entitled “Allosteric antagonism of insect odorant receptor ion channels” describes the characterisation of an odorant receptor co-receptor (Orco) antagonist that non-competitively inhibits odorant-evoked activation of odorant receptor (OR) complexes. One VUAA1 analog, VU013254 was found to be a specific allosteric modulator of OR signalling, capable of broadly inhibiting odor-mediated OR complex activation. Delta-undecalactone was used simply as an experimental tool as an odorant receptor stimulator in whole-cell patch clamp recording assays of induced currents in OR expressing cells.

Pask G. M. et al (2013) Chem. Senses 38: 19-25 “The molecular receptive range of a lactone receptor in Anopheles gambiae” This scientific article describes the testing of a range of lactone compounds found in nature and which are the basis of many natural odours, e.g. emitted by fruits. AgOr48 is the odorant-sensitive OR lactone receptor from An. gambiae. AgOr48 is heterologously expressed in a human cell line and voltage-clamp and calcium imaging are used to investigate the molecular receptive range of the receptor. No particular functional significance is attached to any of the lactones tested. Delta-undecalactone is only one of a number tested. The authors suggest that the lactone specificity of AgOr48 plays a role in the attraction of mosquitoes to sugar sources.

There is an urgent need for additional and/or improved insect repellent compounds. The inventors have surprisingly found that δ-decalactone and δ-undecalactone each have significant mosquito repellent activity which is similar to or better than that of DEET. Moreover, whereas the activity of DEET has no spatial effect on distances from the human skin greater than a few millimeters, δ-decalactone and δ-undecalactone both have a significant repellent effect from a distance of at least several decimeters.

### DISCLOSURE OF THE INVENTION

Accordingly, the present invention provides δ-decalactone and/or δ-undecalactone for use as an insect repellent.

δ-decalactone and/or δ-undecalactone are volatile liquid compounds at room temperature. The inventors consider that these compounds exert their repellent effect when in the airspace that the insects come into contact with. Therefore, the active compound(s) of the invention are preferably provided for use in a suitable vehicular form, such as a solid, semi-solid, gel, liquid, either or not micro-encapsulated, from which the compounds may volatilize or be volatilized, for example, by heating and/or venting. If in the form of a liquid, volatilization may be achieved by spraying, for example.

δ-decalactone may be used separately of and from δ-undecalactone in providing an insect repelling effect. However, a combination of the two compounds may also be used in a suitable ratio.

δ-decalactone or δ-undecalactone, when used as an insect repellent in accordance with any aspect of the invention may be undiluted, i.e. 100% (v/v) liquid form of the compound. Preferably though, the δ-decalactone or δ-undecalactone will be used in a less concentrated form, for example in a suitable vehicle in a concentration of from about 0.1% to about 99% (v/v). In preferred embodiments, the δ-decalactone or δ-undecalactone is provided at a concentration in suitable vehicle of about 0.25% to about 75% (v/v); preferably from about 0.5% to about 50% (v/v); even more preferably about 0.75%-25% (v/v). An effective composition may comprise about 1% (v/v) in a suitable diluting vehicle.

As a vehicle or carrier employed in forming liquid formulations, there may be used, for example, alcohols such as ethanol, glycerin and polyethylene glycol; acetone, ethers such as tetrahydrofuran and dioxane; aliphatic hydrocarbons such as hexane, kerosine, paraffin and petroleum benzene; and esters such as ethyl acetate. The liquid formulation may be impregnated into different types of textile fabrics, such as cotton, polyamides (nylon), polyesters, super-absorbent gels (SAPs) or suitable mixtures of these.

A preferred dilution vehicle is an alcohol, e.g. ethanol. In the case of δ-decalactone the vehicle is preferably an oil, for instance a mineral or vegetable oil.

When used in combination, the aggregate concentration of δ-decalactone or δ-undecalactone may be 100% (v/v) or fall within one of the aforementioned ranges of concentration in a suitable vehicle.

δ-decalactone and δ-undecalactone when used as described above, may further be used in combination (as aforementioned), separately, sequentially or simultaneously. When used separately, δ-decalactone and δ-undecalactone may be used in same or different vehicles at same or differing concentration.

In other embodiments, the δ-decalactone and/or δ-undecalactone may be used with a further insect repellent. When used in combination simultaneously there is a mixture of the repellents in the composition, optionally in a suitable vehicle.

When a further insect repellent is used separately with the δ-decalactone and/or δ-undecalactone (whether or not simultaneously), the further insect repellent may be present in the same or a different type of vehicle, but not in the form of a mixed composition with the δ-decalactone and/or δ-undecalactone. For example, δ-decalactone may be provided in an oleaginous form, whereas the further insect repellent (other than δ-undecalactone) may be provided separately in an organic solvent.

Whether a further insect repellent is presented in the same or different type of vehicle as that used for δ-decalactone and/or δ-undecalactone, and whether or not as a mixture with the δ-decalactone and/or δ-undecalactone, the further insect repellent may be used together with the δ-decalactone and/or b-undecalactone in an area or airspace in a spatially and/or temporally separate manner. This may be spatially and/or temporally distinct.

In other aspects there may be at least partial spatial and/or temporal overlap of release of δ-decalactone and δ-undecalactone. In aspects involving further insect repellents, there may be at least partial spatial and/or temporal overlap in release of the further repellents with the release of δ-decalactone and δ-undecalactone into the air.

Any further insect repellent may be selected from 6-methyl-5-hepten-2-one (6MHO), linalool (LNL), N,N-diethyl-meta-toluamide (DEET) and p-Menthane-3,8-diol (PMD), for example.

However, any suitable further insect repellent substance may be used, including natural products.

δ-decalactone and/or δ-undecalactone when used in accordance with any aspect of the invention as defined above may be used in combination with a spatially separate insect attractant or trap, so as to create a push-pull form of insect control.

In alternative aspect, the invention includes δ-decalactone and/or δ-undecalactone for use as an insect repellent, wherein the δ-decalactone and/or δ-undecalactone is formulated for topical application on a human or animal.

In any aspect of the invention, the insect is of the order Diptera, and preferably a mosquito; preferably wherein the mosquito is of a species or subspecies of a genus selected from Anopheles, Aedes, Culex, Culiseta, Haemogogus, Mansonia and Psorophora. The invention is preferably applied to dealing with a species or subspecies of mosquito of the genus Anopheles; more particularly a subspecies or variant of the species An. gambiae.

The invention is also preferably applied to dealing with a species or subspecies of mosquito of the genus Aedes; more particularly Aedes aegypti.

The invention also provides a composition comprising δ-decalactone and/or δ-undecalactone in a cream, lotion, ointment, spray, gel or solid vehicle suitable for topical application to human or animal or on clothing as carrier material, such as textile fabrics. In preferred compositions there is at least 1% (w/w) δ-decalactone and/or δ-undecalactone.

The invention further provides a composition for making articles such as bed nets and screens comprising δ-decalactone and/or δ-undecalactone in a synthetic resin. The resin may be extrudible or mouldable into the desired articles. The invention therefore includes an extrudible or mouldable material containing δ-decalactone and/or δ-undecalactone. Any articles of utility may be made from such resins containing δ-decalactone and/or δ-undecalactone so that they may have insect repelling effect. The concentration of δ-decalactone and/or δ-undecalactone in the resin is such that a resultant article preferably comprises at least about 1% (w/w) δ-decalactone and/or δ-undecalactone.

The invention includes a fabric, textile, mesh or net, coated and/or impregnated with δ-decalactone and/or δ-undecalactone. Such fabric, textile, mesh or net may be made from natural or synthetic material. The coating and/or impregnation may be carried out after the formation of the material, or after the making of articles from the material. The articles made of fabrics or textile may be items of clothing. The meshes or nets may be bed nets. In preferred embodiments, the finished articles may be coated or impregnated so that they comprise at least about 1% (w/w) δ-decalactone and/or δ-undecalactone.

The invention also provides insect repellent apparatus comprising a container containing a composition comprising δ-decalactone and/or δ-undecalactone. The container may be in fluid connection with an orifice which can be exposed to the air, or a porous surface which can be exposed to the air.

In preferred embodiments, the container and orifice provide discharge of composition into the air; optionally wherein the container containing the composition is pressurised. Most preferably the apparatus is in the form of an aerosol device and the composition includes a suitable propellant as hereinbefore described.

In other embodiments, the insect repellent apparatus has a porous surface from which a composition of the invention evaporates the δ-decalactone and/or δ-undecalactone active agents into the air. Optionally, at least a portion of the porous surface is heated.

The invention also includes a kit comprising a first container containing a composition comprising δ-decalactone and/or δ-undecalactone, and in a second, spatially separate container an insect attractant composition optionally combined with trapping and/or killing device. The first and second containers may be in the form of any of the repellent apparatus or repellent devices described herein.

Accordingly, the invention also provides a push-pull system of insect control comprising insect repellent apparatus or device as described herein, and a spatially separate insect attractor, trap or killer. Such attractors, traps or killers are well known to a person of skill in the art and are readily available from a wide range of commercial suppliers. For example, commercially available attractant mosquito traps are produced by Biogents AG, Regensburg, Germany; or Bioquip of California, USA.

The invention includes a method of controlling insects in an area, comprising releasing δ-decalactone and/or δ-undecalactone at one or more locations in and/or outside of the area. Preferably, the δ-decalactone and/or δ-undecalactone is released directly into the air.

In further embodiments of this method of the invention, one or more insect attractors, traps or killers may be located in and/or outside of the area, the insect attractors, traps or killers being at spatially separate locations from the release of δ-decalactone and/or δ-undecalactone in and/or outside of the area.

In other methods in accordance with this aspect, the δ-decalactone and/or δ-undecalactone may be released inside the area and the insect attractors, traps or killers are located outside the area.

As will be appreciated, the invention therefore offers complete flexibility in terms of providing optimal push-pull insect management system for any given situation in the field.

The invention will now be described in detail with reference to examples and having regard to the drawings in which:

### BRIEF DESCRIPTION OF DRAWINGS

FIG. 1 shows a perspective and schematic view of the apparatus used for candidate repellent bioassay.

FIG. 2 is a chart showing the effect of a selection of compounds on the number of landings made by a group of Anopheles gambiae s.s. females during eight minutes.

FIG. 3 shows the experimental setup for example 2.

FIG. 4 shows the number of mosquitoes trapped inside and outside the experimental house of example 2.

FIG. 5 shows mean number of landings on the control and the treated fabrics at zero, one, three and six months after treatment in example 3.

FIG. 6 shows mean number of mosquitoes caught inside the houses in example 3.

FIG. 7 shows mean number of anopheline mosquitoes caught inside the houses.

FIG. 8 shows model simulations showing the entomological inoculation rate (EIR) as a function of different levels of push efficacy.

FIG. 9 shows model simulations showing the entomological inoculation rate (EIR) as a function of different levels of pull efficacy.

FIG. 10 shows model simulations of a scenario in which mosquitoes are highly resistant against insecticides

FIG. 11 shows model simulations of a scenario in which mosquitoes are highly resistant against insecticides.

### DETAILED DESCRIPTION

In the context of the present invention, and in accordance with World Health Organisation (WHO) 2013, the term “repellent” is used to refer to a compound that has a behavioural effect on mosquitoes which results in a reduction in human-vector contact and therefore personal protection. These behavioural effects thus include ‘movement away from the source’ (repellency in the strict sense) as well as ‘inhibition of attraction’ (interference with host detection and/or feeding response).

In liquid formulations of the invention, it is possible to blend the δ-decalactone and/or δ-undecalactone with commonly used adjuvants or auxiliary agents such as emulsifying or dispersing agent, spreading agent, wetting agent, suspending agent, preservative, propellant and film-forming agent. Examples of the emulsifying or dispersing agents usable in the present invention include soaps, polyoxyethylene fatty acid-alcohol ethers such as polyoxyethylene oleyl ether, polyoxyethylene alkylaryl ethers such as polyoxyethylene nonylphenyl ether, polyoxyethylene fatty acid esters, fatty acid glyceride, sorbitan fatty acid esters, sulfuric esters of higher alcohols, and alkylaryl sulfonates such as sodium dodecylbenzenesulfonate; examples of the spreading and wetting agents include glycerin and polyethylene glycol; examples of the suspending agents include casein, gelatin, alginic acid, carboxymethyl cellulose, gum arabic, hydroxypropyl cellulose and bentonite; examples of the preservatives include methyl p-hydroxybenzoate, ethyl p-hydroxybenzoate, propyl p-hydroxybenzoate, and butyl p-hydroxybenzoate; examples of the propellants include dimethyl ether, chlorofluorocarbons and carbon dioxide; and examples of the film forming agents include nitrocellulose, acetyl cellulose, acetylbutyl cellulose, methyl cellulose derivatives, vinyl resins such as vinyl acetate resin, and polyvinyl alcohol.

The carriers usable in the preparation of cream formulations include hydrocarbons such as liquid paraffin, vaseline and paraffin; silicones such as dimethylsiloxane, colloidal silica and bentonite; monohydric alcohols such as ethanol, stearyl alcohol, lauryl alcohol and cetyl alcohol; polyhydric alcohols such as polyethylene glycol, ethylene glycol and glycerin; carboxylic acids such as lauric acid and stearic acid; and esters such as beeswax and lanoline. In the cream formulations, there may also be blended the adjuvants or auxiliary agents same as used in any of the liquid formulations described herein.

In embodiments of the invention which involve the making of articles from synthetic resin and impregnated with δ-decalactone and/or δ-undecalactone, the synthetic resins usable for forming the resin mouldings include polyethylene; polypropylene; copolymers of ethylene and monomers having polar groups, such as ethylene-vinyl acetate copolymer, ethylene-methyl acrylate (or methacrylate) copolymer, ethylene-ethyl acrylate copolymer, and ethylene-vinyl acetate-methyl acrylate (or methacrylate) copolymer; and chlorine-containing synthetic resins such as polyvinyl chloride and polyvinylidene chloride. Of these substances, ethylene-vinyl acetate copolymer or ethylene-methyl methacrylate copolymer are preferred in view of their thermoforming properties (low-temperature processability), diffusibility and stability.

Impregnation of δ-decalactone and/or δ-undecalactone into a synthetic resin can be effected by having the compound(s) impregnated in the base synthetic resin directly whereby the active compound(s) are already in a suitable solvent such as acetone, or by mixing the active compound(s) and a synthetic resin in a molten state. In the latter case, a process may be employed in which the master pellets are first prepared by mixing the active agents oil in a high concentration and a synthetic resin in a molten state, and these master pellets, either directly or after diluted with the base synthetic resin to contain a predetermined amount of active agent compound are moulded into a desired product such as film, sheet, net, etc., by a method usually used for moulding of thermoplastic resins, such as injection moulding, inflation or spinning. It is also possible to apply multilayer moulding, composite spinning or other moulding methods depending on the purpose of use of the moulded product, such as controlling the insect repelling effect retention time.

In any of the liquid formulations of δ-decalactone and/or δ-undecalactone in accordance with any aspect or use of the invention described herein, the concentration of δ-decalactone and/or δ-undecalactone active agents in the liquid may be in a range (all % (v/v)) selected from: about 1% to about 100%, about 2% to about 90%, about 3% to about 80%, about 4% to about 75%, about 5% to about 70%, about 6% to about 65%, about 7% to about 60%, about 8% to about 55%, about 9% to about 50% or about 10% to about 45%. Other ranges include about 1% to about 40%, about 1% to about 35%, about 1% to about 30%, about 1% to about 25%, about 1% to about 24%, about 1% to about 23%, about 1% to about 22%, about 1% to about 21%, about 1% to about 20%, about 1% to about 19%, about 1% to about 18%, about 1% to about 17%, about 1% to about 16%, about 1% to about 15%, about 1% to about 14%, about 1% to about 13%, about 1% to about 12%, about 1% to about 11%, about 1% to about 10%, about 1% to about 9%, about 1% to about 8%, about 1% to about 7%, about 1% to about 6%, about 1% to about 5%, about 1% to about 4%, about 1% to about 3%, about 1% to about 2%. Other ranges to be read in conjunction with the aforesaid ranges include: about 1% to about 40%, about 2% to about 40%, about 3% to about 40%, about 4% to about 40%, about 5% to about 40%, about 6% to about 40%, about 7% to about 40%, about 8% to about 40%, about 9% to about 40%, about 10% to about 40%, about 11% to about 40%, about 12% to about 40%, about 13% to about 40%, about 14% to about 40%, about 15% to about 40%, about 16% to about 40%, about 17% to about 40%, about 18% to about 40%, about 19% to about 40%, about 20% to about 40%, about 21% to about 40%, about 22% to about 40%, about 23% to about 40%, about 24% to about 40%, about 25% to about 40%, about 26% to about 40%, about 27% to about 40%, about 28% to about 40%, about 29% to about 40%, about 30% to about 40%, about 31% to about 40%, about 32% to about 40%, about 33% to about 40%, about 34% to about 40%, about 35% to about 40%, about 36% to about 40%, about 37% to about 40%, about 38% to about 40%, about 39% to about 40%.

In any of the formulations of or for use in accordance with any aspect of the invention as hereinbefore described, whether liquid, gel, cream, ointment, solid (including resin), impregnation into textile fabrics, the amount of δ-decalactone and/or δ-undecalactone present may be in suitable amount, selected from: at least 2% (w/w), at least 3% (w/w), at least 4% (w/w), at least 5% (w/w), at least 6% (w/w), at least 7% (w/w), at least 8% (w/w), at least 9% (w/w), at least 10% (w/w), at least 11% (w/w), at least 12% (w/w), at least 13% (w/w), at least 14% (w/w), at least 15% (w/w), at least 16% (w/w), at least 17% (w/w), at least 18% (w/w), at least 19% (w/w), at least 20% (w/w), at least 21% (w/w), at least 22% (w/w), at least 23% (w/w), at least 24% (w/w), at least 25% (w/w), at least 26% (w/w), at least 27% (w/w), at least 28% (w/w), at least 29% (w/w), at least 30% (w/w), at least 31% (w/w), at least 32% (w/w), at least 33% (w/w), at least 34% (w/w), at least 35% (w/w), at least 36% (w/w), at least 37% (w/w), at least 38% (w/w), at least 39% (w/w), at least 40% (w/w), at least 41% (w/w), at least 42% (w/w), at least 43% (w/w), at least 44% (w/w), at least 45% (w/w), at least 46% (w/w), at least 47% (w/w), at least 48% (w/w), at least 49% (w/w), at least 50% (w/w), at least 51% (w/w), at least 52% (w/w), at least 53% (w/w), at least 54% (w/w), at least 55% (w/w), at least 56% (w/w), at least 57% (w/w), at least 58% (w/w), at least 59% (w/w), at least 60% (w/w), at least 61% (w/w), at least 62% (w/w), at least 63% (w/w), at least 64% (w/w), at least 65% (w/w), at least 66% (w/w), at least 67% (w/w), at least 68% (w/w), at least 69% (w/w), at least 70% (w/w), at least 71% (w/w), at least 72% (w/w), at least 73% (w/w), at least 74% (w/w), at least 75% (w/w), at least 76% (w/w), at least 77% (w/w), at least 78% (w/w), at least 79% (w/w), at least 80% (w/w), at least 81% (w/w), at least 82% (w/w), at least 83% (w/w), at least 84% (w/w), at least 85% (w/w), at least 86% (w/w), at least 87% (w/w), at least 88% (w/w), at least 89% (w/w), at least 90% (w/w), at least 91% (w/w), at least 92% (w/w), at least 93% (w/w), at least 94% (w/w), at least 95% (w/w), at least 96% (w/w), at least 97% (w/w), at least 98% (w/w) or at least 99% (w/w).

In the current best mode, the invention makes use of a liquid formulation of 40% (v/v) 6-undecalactone in paraffin oil. Best results are achievable in a push-pull mode of operation when used together with an active venting mechanism baited with an attractant.

More particularly, the invention is exemplified by the following:

### Example 1

### Laboratory Bioassay of Repellent Compounds

### Bioassay Apparatus and Set Up

The bioassay was set up in a room in which air temperature and relative humidity (RH) could easily be controlled. During experiments these parameters were continuously monitored using a Tinyview® data logger with display. Temperature was maintained at 24±1° C. and RH was kept between 60 and 75%.

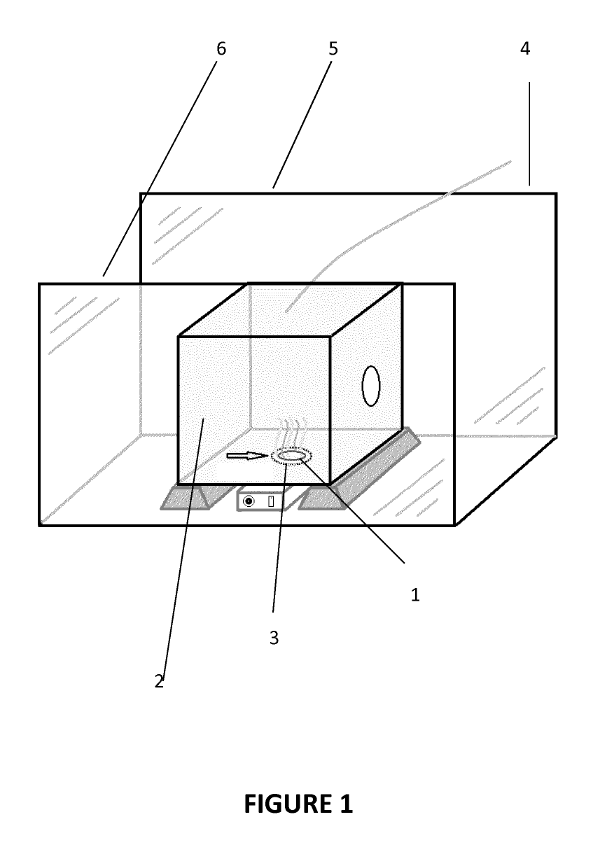

Because repellents are volatile compounds, the risk of contamination of the setup is always present when testing these substances. Therefore, this bioassay uses replaceable 30×30×30 cm Bugdorm® cages as flight chambers. The apparatus used is shown in FIG. 1. Although made of polyethylene (PE) and polypropylene (PP) which may potentially pick up the compounds tested, no contamination effects were observed, in contrast to a previously used cage made of metal and polycarbonate (see below).

Mosquitoes were attracted to a heated circular plateau (1) of diameter 15 cm acting as a landing surface, that was positioned underneath the gauze bottom of the Bugdorm® (2). Ten moist filter papers (3) of diameter 8 cm were applied on top of the heating plateau. Metal gauze was placed over the papers on which the strips releasing the odour blend were laid (see below). A transparent plastic cylinder was placed around the plateau to concentrate the warm, humid air within the area above the plateau. The temperature in the middle of the bottom of the Bugdorm® was kept at 34±2° C., comparable to the temperature of human skin.

A five-compound odour bait, which simulates the smell of a human foot (Mukabana et al., 2012), provided the necessary attractive background against which repellency could be measured. The individual compounds were released from nylon strips (cut from panty hoses: 90% polyamide, 10% spandex, Marie Claire®) (see Okumu et al. (2010b)). Concentrations were optimized for this release method: ammonia (25%), L-(+)-lactic-acid (88-92%), tetradecanoic acid (16% in ethanol), 3-methyl-1-butanol (0.01% in paraffin oil) and butan-1-amine (0.001% in paraffin oil). Strips measuring 26.5 cm×1 cm were impregnated with the attractive compounds by dipping them into an Eppendorf tube containing 1 ml of solution. Subsequently, they were stored at room temperature for three to five hours. Hereafter the strips were hung for half an hour under a fume hood to allow excess fluids to leak off. Finally they were packed in aluminium foil and stored at 4° C. in a refrigerator until use. Pulses of CO₂ were released into the Bugdorm® through a teflon tube (4) that rested on top of the Bugdorm®. Each eight seconds, a two second pulse was released at 2.17 mL/sec (or 130 mL/min).

A glass screen (5, 6) was placed between the Bugdorm® and the place from where a researcher would carry out the behavioural observations. In this way, skin and breath emanations from the researcher were prevented from interfering directly with the mosquitoes inside the flight chamber. In the ceiling of the experimental room a fan created a gentle suction to carry off any volatiles emitted by both the experimental operator and the setup.

### Measuring Repellence

Repellence was measured by releasing a number of female Anopheles gambiae s.s. mosquitoes into the cage. The mosquitoes were highly attracted to the warm area on the bottom of the Bugdorm® cage and they would land and probe with their proboscis through the gauze in search of a blood-host.

A potential repellent was released from a nylon strip that was prepared identically to the method used for attractive compounds, with the exception that the strips were not hung up under a fume hood but stored in Eppendorf tubes at 4° C. directly after their preparation. The impregnated nylon strips with the repellents were taken out of their solution just before the start of the experiment and allowed to leak out on a piece of filter paper for 10 s before they were placed in the experimental setup. Strips were laid directly on the gauze bottom of the Bugdorm®, in a circle within the circular area under which the attractant blend was released.

After one minute of acclimatization time, the number of landings within the circular area formed by the treated strip was counted for a period of eight minutes. A “landing” is defined as the total period for which a mosquito maintains contact with the landing platform. Walking/hopping around on the landing plateau, as well as short (<1 s) take-offs immediately followed by landing again, are included in one landing. A new landing is recorded when a mosquito has left the plateau for more than one second before landing again. Landings shorter than one second during which no probing took place are ignored.

### Mosquitoes

The mosquitoes (Anopheles gambiae s.s.) used in the experiments were reared in climate chambers at the Laboratory of Entomology of Wageningen University, The Netherlands. The founding population was collected in Suakoko, Liberia. Mosquitoes were kept under photo:scotophase of 12:12 hours at a temperature of 27±1° C. and relative humidity of 80±5%. Adults were kept in 30×30×30 cm gauze wire cages and had access to human blood on a Parafilm® membrane every other day. A 6% glucose solution in water was available ad libitum. Eggs were laid on wet filter paper and then placed in a plastic tray with tap water for emergence. Larvae were fed on Liquifry® No 1 (Interpet, UK) for the first three days and then with TetraMin® baby fish food (Tetra, Germany) until they reached the adult stadium. Pupae were collected from the trays using a vacuum system and placed into a plastic cup filled with tap water for emergence.

The mosquitoes subjected to the experiments were placed in separate cages as pupae. They had access to a 6% glucose solution but received no blood meals. The day before the experiment, five to eight day-old female mosquitoes were placed in release cages with access to tap water in cotton wool until the experiment. Both experiments took place during the last four hours of the scotophase, a period during which Anopheles gambiae s.s. females are highly responsive to host odours (Maxwell et al. (1998)).

### Experimental Design

The experiment comprised thirteen treatments: a non-treated strip (NTR) to determine the effect of the solvent; an ethanol treated strip (ETH) as negative control (all compounds were dissolved in ethanol); a DEET treated strip and a PMD treated strip as positive controls (the PMD treatment was again based on Citriodiol™) and strips treated with nine different candidate repellents. These were: 1-dodecanol (1DOD), 2-nonanone (2NON), 6-methyl-5-hepten-2-one (6MHO), 2,3-heptanedione (23HD), 2-phenylethanol (2PHE), eugenol (EUG), delta-decalactone (dDL), delta-undecalctone (dUDL) and linalool (LNL). All compounds were tested at a 1% concentration.

The number of replicates was eight for each treatment. Each treatment got assigned a different, new Bugdorm®. All replicates of that treatment took place in the same Bugdorm®. Within each repetition the order in which the treatments were tested was fully randomized.

For each individual test, ten naive Anopheles gambiae s.s. females were released into the Bugdorm®. After one minute acclimatization time, their behaviour was observed for eight minutes as described under the heading ‘measuring repellence’.

### Statistical Analysis

For both experiments, the number of landings that was observed for the different treatments was compared to a solvent-only treatment that served as a control. The Shapiro-Wilk test was used to test the normality of the data. Levene's test was used to test for equality of variances.

When normality and/or equality of variances had to be rejected, non-parametric tests were used for further analysis. A Kruskal-Wallis test was used to determine if there was an effect of the treatments, followed by multiple Mann-Whitney U tests to determine significant effects compared to the control. The significance level (a) of the individual M-W U tests was adjusted for the number of comparisons, using the Bonferroni correction.

### Results

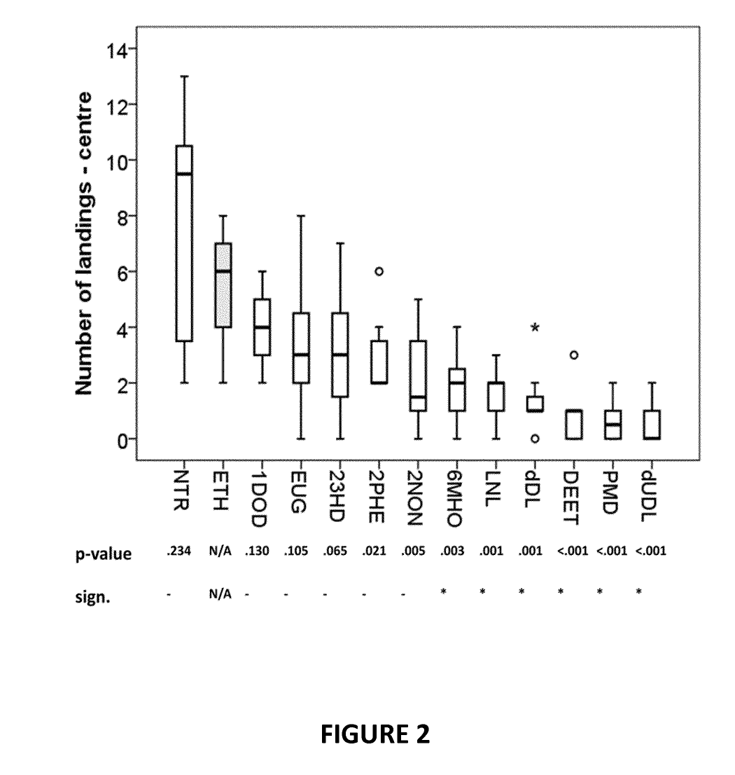

A significant effect of treatment on the number of landings was observed (Kruskal-Wallis test; p<0.001) and differences between the control (ethanol) and the other groups were determined using multiple Mann-Whitney U tests (at α=0.0042). FIG. 2 shows that six compounds significantly reduced the number of landings. In order of increasing efficacy: 6-methyl-5-hepten-2-one, linalool, delta-decalactone, DEET, PMD and delta-undecalactone. Boxplots show the median value, the lower and upper quartile and the lowest and highest value within 1.5 IQR for all treatments. A circle indicates an outlier and an asterisk indicates an extreme outlier. Significance is indicated for p values <0.0042, n=8 for all treatments.

The two lactones, δ-decalactone and δ-undecalactone were found to have a strong repellent effect on host-seeking mosquitoes.

### Example 2

### Semi-Field Testing of Candidate Repellent Compounds

### Mosquitoes

Mosquitoes (An. gambiae s.s., Mbita strain; henceforth termed An. gambiae) were reared under ambient atmospheric conditions in screenhouses (larvae) and holding rooms (adults) at the Thomas Odhiambo Campus (TOC) of the International Centre of Insect Physiology and Ecology (ICIPE) located near Mbita Point township in western Kenya. Mosquito eggs were placed in plastic trays containing filtered water from Lake Victoria. All larval instars were fed on Tetramin® baby fish food which was supplied thrice per day. Pupae were collected daily and placed in mesh-covered cages (30×30×30 cm) prior to adult emergence. Adult mosquitoes were fed on 6% glucose solution through wicks made from adsorbent tissue paper.

Four to six day old female mosquitoes that had no prior access to blood were used for the semi-field experiments. The mosquitoes were collected from the colony at 12:00 h each day and stored for eight hours in the colony room with access to water on cotton wool. Within 15 min. before the start of the experiment the cups with the mosquitoes were transported to the MalariaSphere.

### Description of the Setup

The experiments were conducted in Kenya at the Mbita Point Research & Training Centre of the International Centre of Insect Physiology and Ecology (ICIPE). Experiments took place in the MalariaSphere, a screenhouse into which a traditional house was built surrounded by natural vegetation (see Knols et al. (2002)). The traditional house possesses an eave, through which mosquitoes that are released into the screenhouse may enter, as they would do in a natural situation when an attractive host is present inside (see Snow (1987)). The MalariaSphere was set up as described by Knols et al. (2002) with as only modification that no breeding sites were present.

### Experimental Design

In the experiment the effects of attractant-baited traps and the dispersal of repellents around the traditional house were tested. Eight different setups were tested. During all tests, one attractant-baited trap (see below) was placed inside the experimental house to represent a human being. The house entry of the mosquitoes was measured by the number of mosquitoes caught by the trap inside the house.

Each night at 20:00 h, 200 female mosquitoes were released into the MalariaSphere. At 06:30 h the next morning the experiment was terminated by closing and switching off all traps. The traps were then placed in a freezer for several minutes to inactivate the mosquitoes, after which the number of trapped mosquitoes was determined.

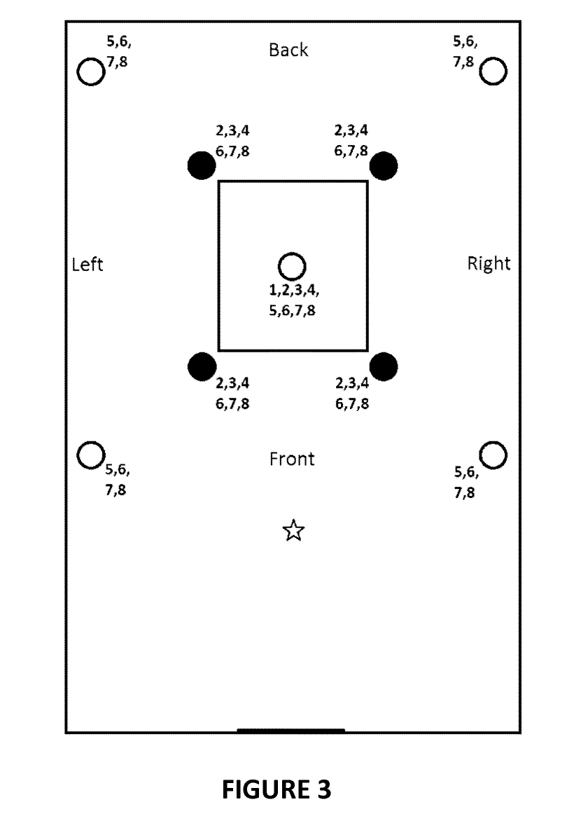

The study compared the effect of three different repellents; in push-only situations, as well as in situations in which both the repellent and the attractive elements were present. FIG. 3 shows the experimental setup. Open circles represent a MMX trap baited with attractant. Filled circles represent a MMX trap dispersing the repellent. The asterisk indicates the mosquito release point. The numbers of the treatments correspond to the following:

| Treatment | Description |
|---|---|
| 1 | Push only PMD |
| 2 | Push only catnip |
| 3 | Push only δ-undecalactone |
| 4 | Control |
| 5 | Pull only |
| 6 | Push-pull PMD |
| 7 | Push-pull catnip |
| 8 | Push-pull δ-undecalactone |

Each setup was tested during six different nights, thus a total of 48 tests was carried out, during the same number of nights. The order of the tests was not fully randomized in order to minimize the risk of contamination of the MalariaSphere with the odours used.

Besides PMD, catnip essential oil (e.o.) and delta-undecalactone (dUDL) were used as repellents. Strips were impregnated with 40% solutions (catnip e.o. and dUDL were dissolved in paraffin oil) as described below.

Each night 200 mosquitoes were released from one central point between the entrance of the screenhouse and the experimental hut (see FIG. 3).

### The Attractant-Baited Traps

Mosquito Magnet® X (MM-X) traps (Kline (1999), Njiru et al (2006)) were baited with CO₂ and a five-compound odour blend, which simulates the smell of a human foot (Mukabana et al., 2012). The individual compounds of the attractive blend were released from nylon strips (cut from panty hoses: 90% polyamide, 10% spandex, Marie Claire®) (Okumu et al. (2010b)). Concentrations were optimized for this setup and release method: ammonia (2.5% in water), L-(+)-lactic-acid (88-92%), tetradecanoic acid (0.000032% in ethanol), 3-methyl-1-butanol (0.000001% in water) and butan-1-amine (0.001% in paraffin oil) (see Table 1).

TABLE 1
Composition of the attractive blend.

| Compound | Concentration | | Solvent |
|---|---|---|---|
| Ammonia | 2.5% | (v/v) | water |
| L-(+)-lactic acid | 88-92% | (w/w) | water |
| Tetradecanoic | 0.000032% | (w/w) | ethanol |
| acid | | | |
| 3-Methyl-1- | 0.000001% | (v/v) | water |
| butanol | | | |
| Butan-1-amine | 0.001% | (v/v) | paraffin oil |

Strips measuring 26.5 cm×1 cm were impregnated with the attractive compounds by dipping (experiment 1) three strips in 3.0 ml of compound in a 4 ml screw top vial (experiment 2) individual strips into an Eppendorf tube containing 1 ml of solution. Before use, strips were dried for 9-10 hours at room temperature. Experiment 1: For every experimental night, a set of freshly impregnated strips was used. Experiment 2: Strips were used for a maximum of 12 nights in a row. During daytime, the strips were packed in aluminium foil and stored at 4° C. in a refrigerator.

The five strips were held together with a safety pin and hung in the outflow opening of the MM-X trap using a plastic covered clip. CO₂ was produced by mixing 17.5 g yeast with 250 g sugar and 2.5 L water (method by Smallegange et al. (2010)) and released from the MM-X trap together with the odours.

MM-X traps equipped with the attractive blend were positioned with the outflow opening at the optimal height of 15-20 cm above the floor surface (Jawara et al. (2009)).

### Dispersal of the Repellents

To disperse the repellents, MM-X traps were used of which the suction mechanism was disabled, leaving only the outflow mechanism functional (see Okumu et al. (2010a)). The repellent compounds were applied to nylon strips identically to the attractants. However, because of their volatility the strips with repellent were dried at for a much shorter period. During experiment 1, strips were dried for one hour; during experiment 2 for only ten minutes. One repellent strip was used per MM-X trap. Fresh strips were used each night.

The MM-X traps that dispersed the repellent were hung from the lowest part of the roof of the traditional house, with the outflow opening about 1 m above the floor, to intercept mosquitoes that would enter through the eaves of the experimental hut.

### Statistical Analysis

For both experiments, the trap catches inside and (when applicable) outside the experimental house were compared between all treatments. The Shapiro-Wilk test was used to test the normality of the data and Levene's test was used to test for equality of variances.

Subsequently, the differences between trap catches inside the house in experiment 1 were analysed using analysis of variance (ANOVA) followed by Bonferroni post-hoc tests. Trap catches outside were compared using an independent-samples t-test.

For the trap catches inside the house in experiment 2 there was a strong deviation from equality of variances (p=0.001). Differences between trap catches inside the house were analysed using ANOVA followed by Games-Howell post-hoc tests. Trap catches outside the house were compared using ANOVA followed by Bonferroni post-hoc tests.

### Results

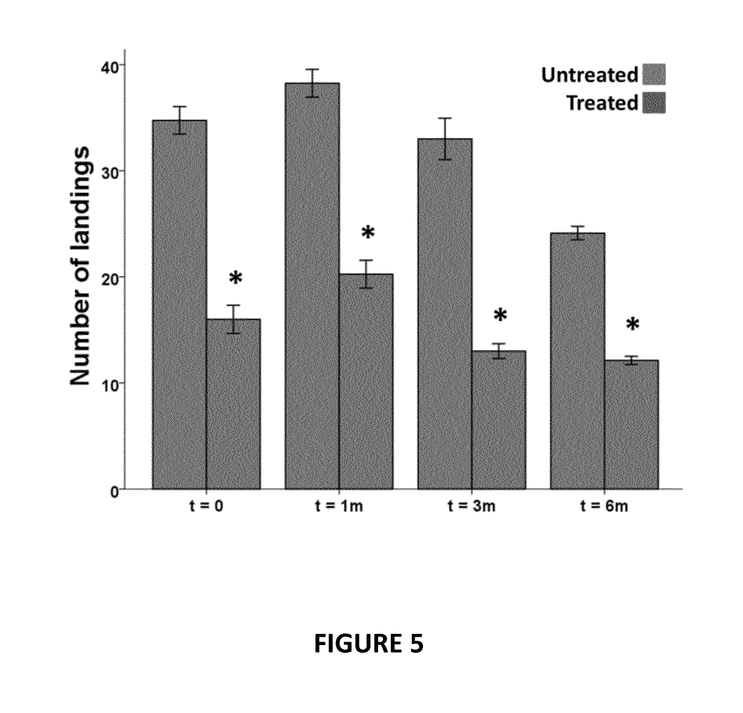

Without any dispersion of repellents or removal trapping, the attractant baited trap inside the house caught 82.0 (4.0) mosquitoes on average; 41.0% of the total number released. All treatments significantly reduced the number of mosquitoes trapped inside the experimental house (ANOVA: F=70.08, df=7, p<0.001; Games-Howell post-hoc tests at α=0.05, see table 5 and FIG. 5).

The push-only treatment with delta-undecalactone resulted in a considerably stronger reduction (81.5%) than the treatments with PMD or catnip essential oil (45.7% and 56.5% resp.), of which catnip essential oil performed slightly better. Removal trapping (pull only) led to 82.3% reduction, with the trap inside the house catching only 14.5 (2.0) mosquitoes on average. The push-pull treatment with delta-undecalactone as a repellent provided the strongest reduction, 95.5%; only 3.7 (0.7) mosquitoes were caught inside the house on average; 1.9% of the total number released. The total number of mosquitoes trapped outside did not differ significantly between the treatments that included removal trapping.

Table 2 shows the trap catches inside and outside the traditional house, under the different treatments; n=6 for all treatments. 200 mosquitoes were released per night. SEM=Standard Error of the Mean. Characters in italic indicate homogeneous subsets; treatments not sharing the same character are significantly different at α=0.05 according to Games-Howell post-hoc tests.

TABLE 2
Mosquito catches in semi-field experiment

| | Indoors | | | Outdoors | |
|---|---|---|---|---|---|
| | Mean (SEM) | Percentage | | Mean (SEM) no. | Percentage |
| Treatment | no. mosquitoes | trapped | Reduction | mosquitoes | trapped |
| Control | 82.0 (4.0) a | 41.0% | — | n/a | n/a |
| Push PMD | 44.5 (5.6) b | 22.3% | 45.7% | n/a | n/a |
| Push Catnip | 35.7 (4.2) b | 17.9% | 56.5% | n/a | n/a |
| Push dUDL | 15.2 (2.5) c(d) | 7.6% | 81.5% | n/a | n/a |
| Pull | 14.5 (2.0) c | 7.3% | 82.3% | 88.2 (14.3) | 44.1% |
| Push-pull PMD | 6.8 (1.2) c, d | 3.4% | 91.7% | 125.0 (13.8) | 62.5% |
| Push-pull | 5.5 (1.8) c, d | 2.8% | 93.3% | 112.3 (19.6) | 56.2% |
| Catnip | | | | | |
| Push-pull | 3.7 (0.7) d | 1.9% | 95.5% | 122.8 (7.1) | 61.4% |
| dUDL | | | | | |

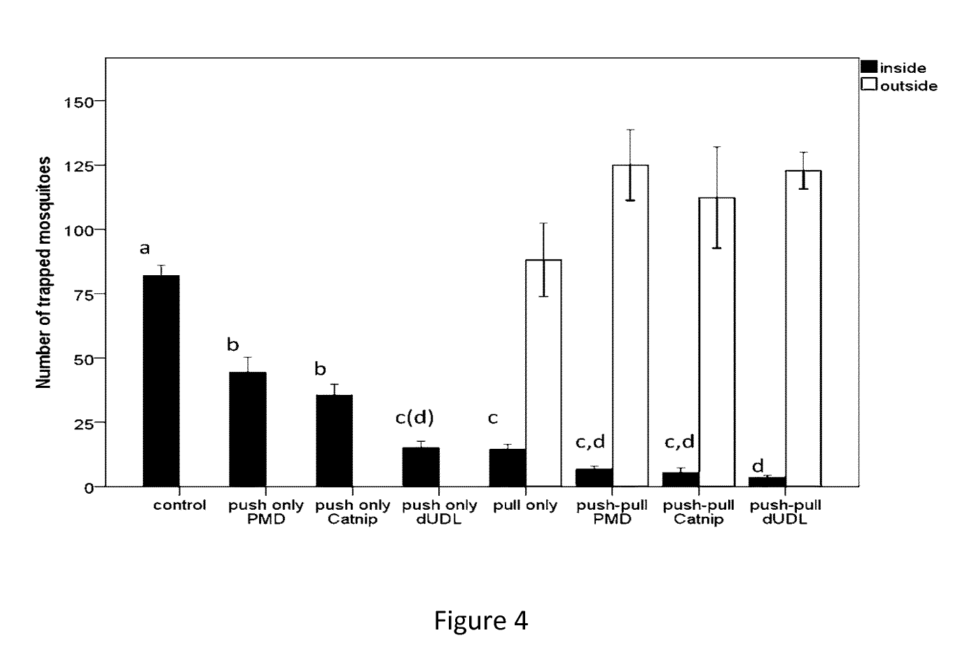

FIG. 4 shows the number of mosquitoes trapped inside and outside the experimental house. n=6 for all groups, error bars indicate the standard error. Bars not sharing the same character are significantly different at α=0.05 according to Games-Howell post-hoc tests. The character ‘d’ is placed between brackets for the push-only dUDL treatment, because its inclusion in the ‘d’ group is based on a p value of 0.05081 for the comparison with the push-pull dUDL treatment.

The repellent baited traps were spaced apart by about 4-5 meters. The inventors observe from the results a significant spatial repellent effect of the δ-decalactone and δ-undecalactone compounds. This is in contrast to DEET which has little or no spatial repellent effect. Therefore the δ-decalactone and δ-undecalactone compounds are particularly advantageous as insect repellent compounds and also advantageous in a “push-pull” system of insect control.

### Example 3

### Laboratory Testing of Delta-Undecalactone

### Attractant

The five-compound odour bait of Table 1 which simulates human scent, was used as an attractant in both the laboratory and field experiments.

### Repellent

The repellent of choice for this study was delta-undecalactone in the form of porous microcapsules “μcaps” (Devan Chemicals, Belgium) which allow slow release of the encapsulated compound over a prolonged period of time.

A 100% cotton net fabric of 65 g/m² (Utexbel, Belgium) was treated with an emulsion of 116 g μcaps per litre (43% active compound). The emulsion was applied by padding, pick up rate was 67%. The fabric was dried and fixed at 110° C. The final product contained 2.18 g dry μcaps per m².

### Mosquitoes

The mosquitoes (An. coluzzii, formerly An. gambiae s.s. form M) used in the laboratory experiment were reared in climate chambers at the Laboratory of Entomology of Wageningen University, The Netherlands. The original population was collected in Suakoko, Liberia.

Mosquitoes were kept under 12:12 h photo:scotophase at a temperature of 27±1° C. and relative humidity of 80±5%. Adults were kept in 30×30×30 cm gauze wire cages and were given access to human blood through a Parafilm® membrane every other day. Blood was obtained from a blood bank (Sanquin Blood Supply Foundation, Nijmegen, The Netherlands). A 6% glucose solution in water was available ad libitum. Eggs were laid on wet filter paper and then placed in a plastic tray with tap water for emergence. Larvae were fed on Liquifry® No 1 (Interpet, UK) for the first three days and then with TetraMin® baby fish food (Tetra, Germany) until they reached the pupal stage. Pupae were collected from the trays using a vacuum system and placed into a plastic cup filled with tap water for emergence.

The mosquitoes intended for the experiments were placed in separate cages as pupae. They had access to a 6% glucose solution but did not receive blood meals. The day preceding the experiment, five to eight day old female mosquitoes were placed in release cages with access to tap water in cotton wool until the experiment. Both experiments took place during the last four hours of the scotophase, a period during which Anopheles gambiae s.s. females are highly responsive to host odours.

### Bioassay

The bioassay was set up in a climate-controlled room of constant air temperature and relative humidity (RH). Temperature was maintained at 24±1° C. and RH was kept between 60 and 75%. During the experiments these parameters were continuously monitored using a Tinyview® data logger with display.

In the bioassay, mosquitoes were attracted to a landing stage: a heated circular plateau (Ø15 cm) that presented the five-compound odour blend and was positioned underneath the gauze bottom of a flight chamber. The temperature in the centre of the landing stage was kept at 34±2° C., comparable to the temperature of human skin, causing the mosquitoes to land and probe with their proboscis through the gauze in search of a blood-host.

### Measuring Repellence

This was as described substantially in Example 1 other than a 15 cm×15 cm cutting of the repellent-treated fabric was compared to an identical cutting of untreated fabric. The fabric was laid down on the bottom of the flight chamber, over the landing stage. Repellence was measured by releasing ten female Anopheles gambiae s.s. mosquitoes into the cage.

### Design and Data Analysis

The treated and the control fabric were tested eight times, with four replicates per day of each, in random order, during two subsequent days. The tests were performed within a week after the treatment had taken place and were repeated after one, three and six months. In between tests, the fabric was stored at 4° C. in a refrigerator. IBM SPSS Statistics 19 was used for data analysis. For the different moments in time, the number of landings on the treated fabric was compared to the control. A Shapiro-Wilk test was used to test for normality. T-tests were performed to determine significant reductions, whereby a was adjusted for the number of comparisons.

### Example 4

### Field Experiment

### Study Site

Kigoche village is located in Kisumu county in western Kenya. It lies adjacent to the Ahero rice irrigation scheme (00°08′19″S, 34°55′50″E) at an altitude of 1,160 m above sea level.

Kigoche has an average annual rainfall of 1,000-1,800 mm and an average relative humidity of 65%. Mean annual temperatures in the area vary between 17° C. and 32° C. Rice cultivation is the main occupation of the inhabitants. Most houses in the village are mud-walled with open eaves, have corrugated iron-sheet roofs, no ceiling and are either single- or double-roomed. Eaves, about 20 cm wide, increase ventilation in the houses and form the predominant entry points for mosquitoes. Malaria caused by Plasmodium falciparum is endemic in the village. The area experiences a long rainy season between April and June and a short rainy season in October-November. During these periods, mosquito breeding sites proliferate, and mosquito populations rapidly increase in size. The domestic animal population constitutes of cattle, goats, sheep, chickens, ducks, dogs and cats, with cattle being most abundant. The main staple food is maize. Rice is mainly grown as a cash crop.

### Houses

Eight traditional, mud-walled houses were selected for the baseline study (see below). The minimum distance between any two selected houses was 30 m, but other (unselected) houses were present around and in between. Based on the outcome of the baseline experiment, four out of the eight houses were selected for the subsequent push-pull experiment (see below).

### Volunteers

Eight volunteers were recruited to sleep in the houses, one person per house, to attract mosquitoes. Volunteers were familiar with and supportive of earlier entomological studies done in Kigoche. After being informed about the nature of the present study, all volunteers gave verbal consent. During the experiment there was daily communication with the volunteers, who had continuous access to artemisinin combination therapy (ACT) in case of infection with malaria.

### Measuring House Entry

Mosquitoes were attracted into a house by a volunteer who was sleeping under an untreated bed net. There were no other people sleeping in the house. The house entry of mosquitoes was determined by CDC light trap catches. A trap was installed at the foot end of the bed, with the top cover hanging approximately 15 cm above the matrass. The light of the trap was disabled, in order to collect only mosquitoes attracted by the volunteer. Power for the fan was supplied by a 6 V dry cell battery. Around the string from which the trap hung down, Vaseline petroleum jelly was applied to prevent ants from reaching the mosquitoes caught in the trap. Every night the eight volunteers rotated amongst the houses. Each night the collection of mosquitoes started at 19:30 h and stopped at 6:30 h in the morning.

Trapped mosquitoes were killed in a freezer and morphologically identified. Culicine mosquitoes were identified to genus level and anophelines were divided into Anopheles funestus sensu lato (s.l.), Anopheles gambiae s.l. and other Anopheles spp. Individual An. funestus s.l. and An. gambiae s.l. mosquitoes were placed into 2 ml Eppendorf tubes with silica gel and a piece of cotton wool to be further identified with a polymerase chain reaction (PCR). The abdominal status of female mosquitoes was categorized as unfed, blood-fed or gravid.

### Interventions

The three interventions that were tested during the field experiment were: (1) a push-only treatment in which only the repellent-impregnated fabric was installed, (2) a pull-only treatment in which an attractant-baited trap was installed outside the house and (3) a push-pull treatment in which both the repellent-impregnated fabric and the attractant-baited trap were in place. Besides these, there was the control treatment, in which a house received neither repellent-impregnated fabric nor an attractant-baited trap.

The repellent was released from a 10 cm wide band of the fabric described above, which was applied inside the eave, around the full circumference of the house. The band was stretched in the lower part of the eave, closing off only the bottom 10 cm but leaving ample space for mosquitoes to enter the house. The control and pull-only treatments received an untreated band of fabric that was applied in a way identical to the treated fabric used in the push and push-pull treatments. Bands remained in place during the full length of the study. Table 3 below is a comprehensive overview of the presence/absence of the specific elements during the treatments:

TABLE 3
Overview of the push and pull elements that were present or absent during
the various interventions.

| Intervention | Fabric in eave | MMX trap outside |
|---|---|---|
| Control | untreated | No |
| Push only | treated | No |
| Pull only | untreated | Yes |
| Push-pull | treated | Yes |

The attractant-baited traps were of the Mosquito Magnet X (MM-X) type baited with the five-compound blend described above and CO₂ produced by the fermentation of molasses by yeast. Traps were installed outside, with the odour outlet positioned at 15 cm above ground level. A 12V battery provided power for the MM-X traps. Surgical gloves were worn when handling the traps, to avoid contamination with human odour.

### Study Design

Preceding the experiment, a baseline study was carried out in order to be able to correct for randomization bias, as treatments would not be rotated between houses to avoid residual effects from blurring the observations. Baseline data would allow us to correct for initial differences between the houses in terms of mosquito entry by using a difference-in-differences method rather than a simple cross-sectional comparison to estimate the impact of the interventions.

The baseline study was conducted during eight subsequent nights (a full rotation of all volunteers), to determine the house entry of mosquitoes for eight different houses. Hereafter, four houses were selected based on the mean number of mosquitoes caught and the variation between the different nights (see details in the results section). Treatments were randomly assigned to the selected houses.

Immediately following the baseline study, the push-pull experiment ran for five subsequent weeks. During the first two rounds of eight nights, sampling took place every night ((n=8)*2). For the last three weeks, sampling took place three nights a week ((n=3)*3). House entry was measured by CDC trap catches, as during the baseline study. IBM SPSS Statistics 19 was used to generate General Linear Models (GLMs) and post-hoc tests.

### Malaria Transmission Model: General Description

To simulate the effect of implementation of the push-pull strategy on a large scale, we adjusted an existing mathematical model (Okumj et al. 2010c). The model describes the most essential activities of malaria mosquitoes in view of malaria transmission. Over 70 parameters describing these activities are included in the model, roughly captured in ecological parameters, intervention parameters and parameters that are derived from combinations of those. The model assumes that the population is exposed homogeneously to mosquitoes, no cumulative or time effects are considered and biting finds place exclusively indoors and during the night. (See Okumu F. O., Govella N. J., Moore S. J., Chitnis N. and Killeen G. F. (2010c) Potential benefits, limitations and target product-profiles of odor-baited mosquito traps for malaria control in Africa. PLoS ONE 5: e11573. doi:10.1371/journal.pone.0011573 for full details concerning the parameterization of all variables and literature references.) Using the entomological inoculation rate (EIR) as a proxy, we determined the effect of a possible push-pull intervention on malaria transmission for a number of scenarios.

Model settings

We used the default settings of the model, with exceptions for the following parameters: Bed net use (Ch) is set at 67%, i.e. ⅔ of the population is assumed to possess a bed net and sleep under it. The model acknowledges the dual efficacy of ITNs, using one parameter to express the excess diversion (θD) and another parameter to express the excess mortality (θm) that a mosquito experiences upon attacking a human being sleeping under an ITN. The latter parameter is adjusted in a second series of scenarios that explored the effect of pyrethroid resistance (see below).

In order to include the influence of repellent-induced house entry reduction (push efficacy) on the EIR, we interpreted this effect as an human being less available to take a blood meal from. Push efficacy is thus represented by reduced availability of all humans (those with and those without a bed net) to take a blood meal from. Thus, when the efficacy of the push (ps) is defined as the fraction of mosquitoes that is prevented from entering the house by the repellent barrier, then the availability of humans (ah) decreases through ah*(1−ps), which results in the relative availability of humans (rah). We used rah instead of ah in all scenarios, considering house entry reduction of 0-100%. In the absence of the push-intervention ps=0, thus rah=ah.

We used the relative attractiveness of the attractant baited traps (At) as a measure for the efficacy of the pull. The efficacy of the pull is the attractiveness of the trap compared to that of a human being, thus when λt=1, the trap is as attractive as a human being. We considered values of 0, 0.5, 1 and 2 for λt. In the absence of the pull intervention λt is set to 0. Availability of odour-baited traps, which in the original model is linked to human availability, was set to 0.0012, its default value, identical to that of a human being in the absence of the push intervention. Each household, assumed to consist of six people, is supposed to possess one odour-baited trap. Therefore, using the default number of people (1000), the number of odour-baited traps is set to 167.

To explore the effects of possible push-pull interventions in a situation where pyrethroid resistance is widespread, the excess mortality that a mosquito experiences upon attacking a human being sleeping under a bed net was reduced in a second series of scenarios. The risk difference, in terms of mortality, for a mosquito attacking someone sleeping under a non-treated net versus someone sleeping under an ITN, was estimated and set to 0.4 (from 0.7 in the default scenarios) to mimic a high resistance situation.

### Results: Laboratory Experiment

FIG. 5 shows mean number of landings on the control and the treated fabrics at zero, one, three and six months after treatment. Asterisks indicate a significant difference between the control and the treatment, n=8 for all groups, error bars indicate the standard error of the mean. At all test moments, t=0, t=1 month, t=3 months and t=6 months, a significant repellent effect was found for the treated fabrics (Independent Samples t-test, p<0.001 for all comparisons). The reduction in the number of landings was of a similar magnitude throughout the different moments: between 47% and 61%.

### Results: Field Experiment

During the entire experiment, 1,791 mosquitoes were caught inside the houses (96.9% female, 3.1% male) of which 1,724 (96.3%) were anophelines and 67 (3.7%) culicines. The anopheline population was made up out of 80.2% An. funestus s.l. and 19.8% An. gambiae s.l. A PCR was performed on a sub-sample of 188 individuals of An. funestus Of the 177 samples that gave a result, all were An. funestus s.s. Out of 184 An. gambiae individuals that were tested with a PCR, 171 gave a result and all were An. arabiensis.

Statistical analyses were done for the overall CDC trap catches and for the anopheline sub-group, other sub-groups were considered too small to carry out reliable statistics, but their values are reported below and more details can be found in Tables S1 and S2 in the supplementary information.

The four houses that were selected for the intervention from the baseline study were the ones that were most similar in terms of mean trap catches and variation over the subsequent nights. Table 4 shows that within the five-week intervention phase, there was no increase or decrease in trap catches as a function of time (GLM with overall CDC trap catches as dependent variable, ‘intervention’ as a fixed factor and ‘week’ as a covariate, full-factorial: p=0.001 for intervention, p=0.629 for week and p=0.711 for intervention*week). Therefore the samples over the whole intervention period were pooled, resulting in 25 replicate measurements for each group.

TABLE 4
Overall mosquito catches during the baseline phase, n = 8 for all houses,
except for house 3 (n = 7). Four houses were selected for the
different interventions.

Baseline

| House | Mean | SD | Intervention |
|---|---|---|---|
| 1 | 21.75 | 6.944 | Push-pull |
| 2 | 6.63 | 3.739 | not selected |
| 3 | 11 | 5.228 | Pull |
| 4 | 15.75 | 4.301 | Control |
| 5 | 14 | 7.091 | Push |
| 6 | 6.25 | 6.819 | not selected |
| 7 | 21.63 | 14.262 | not selected |
| 8 | 7.88 | 3.871 | not selected |

The initial differences between the houses were corrected for by subtracting the mean trap catches of the baseline study from the data obtained during the intervention phase. For a conservative estimate, we used the pooled variance of the intervention phase data, which was larger than the pooled variance of the baseline data, for further testing. The mean trap catches of the different interventions were compared with the control treatment using a GLM followed by Dunnet's post-hoc test. Testing was one-sided (treatment<control) with overall α=0.05.

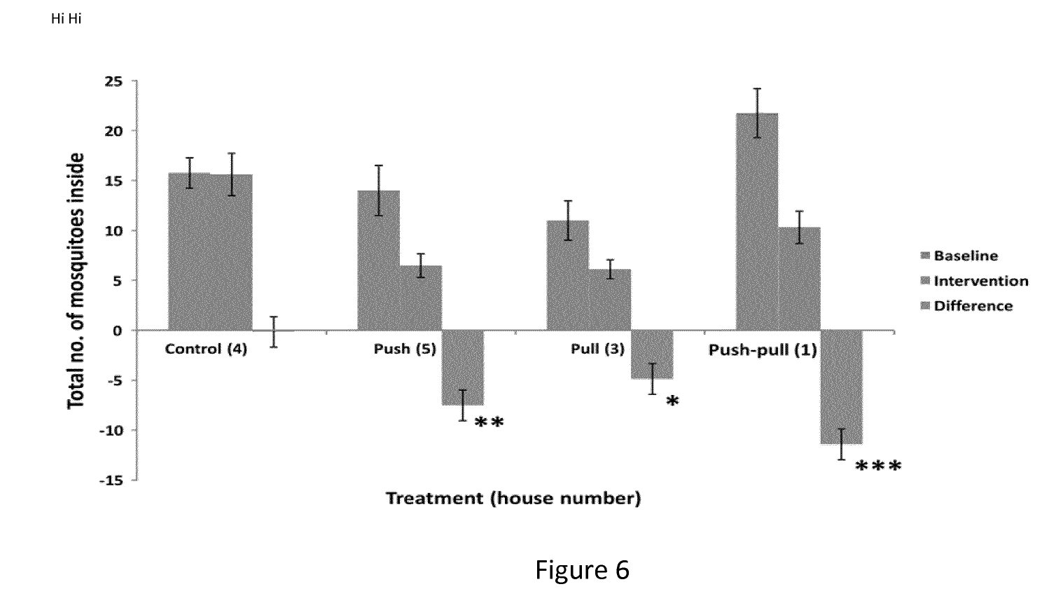

FIG. 6 shows mean number of mosquitoes caught inside the houses. Error bars indicate standard error of the mean (SEM), n=8 for the baseline data (n=7 for house 3) and n=25 for the intervention data. Asterisks indicate a significant difference-in-differences between the control and the intervention: * p<0.05; ** p<0.01; *** p<0.001. Significant reductions in house entry of mosquitoes were found for all interventions. Table 5 shows the push-only intervention reduced mosquito house entry with 52.8% compared to the control. The pull-only intervention reduced mosquito house entry with 43.4% and the push-pull intervention reduced mosquito house entry with 51.6%.

TABLE 5
Mean overall CDC trap mosquito catches for the different
interventions, n = 8 for the baseline data (n =
7 for house 3) and n = 25 for the intervention data.

| Inter- | | Base- | Inter- | Differ- | Differ- | |
|---|---|---|---|---|---|---|
| vention | House | line | vention | ence | ence (%) | Impact |
| Control | 4 | 15.75 | 15.60 | −0.15 | −1.0% | n/a |
| Push | 5 | 14.00 | 6.48 | **−7.52 | −53.7% | −52.8% |
| Pull | 3 | 11.00 | 6.12 | *−4.88 | −44.4% | −43.4% |
| Push-pull | 1 | 21.75 | 10.32 | ***−11.43 | −52.6% | −51.6% |

Asterisks indicate a significant difference-in-differences between the control and the intervention:
*p < 0.05;
**p < 0.01;
***p < 0.001.

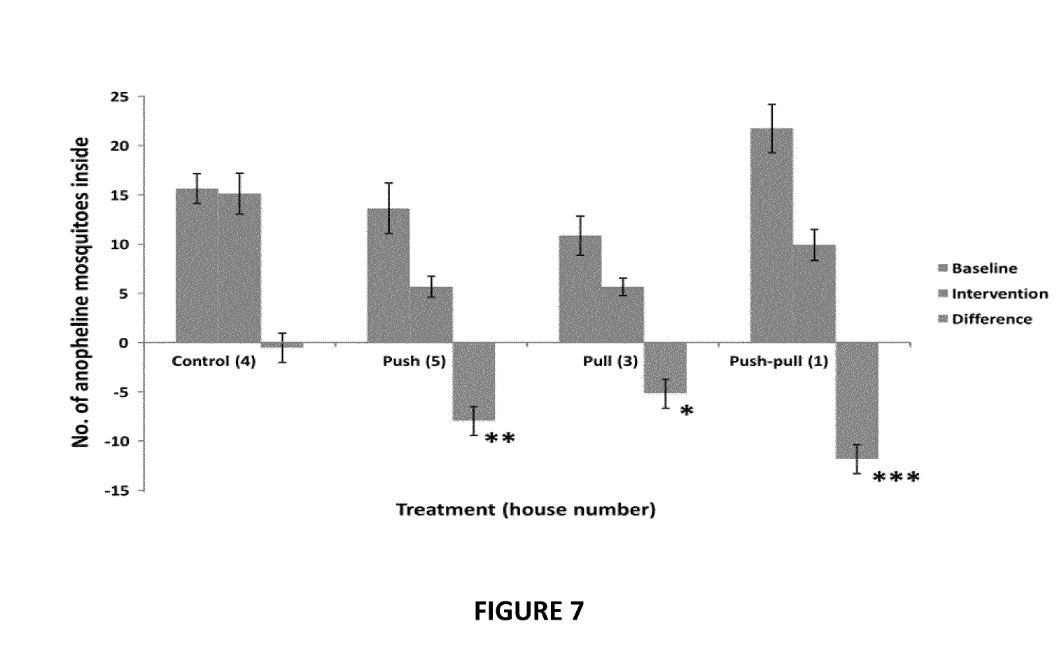

FIG. 7 shows mean number of anopheline mosquitoes caught inside the houses. Error bars indicate standard error of the mean (SEM), n=8 for the baseline data (n=7 for house 3) and n=25 for the intervention data. Asterisks indicate a significant difference-in-differences between the control and the intervention: * p<0.05; ** p<0.01; *** p<0.001. Looking at anopheline mosquitoes only, the results were fairly similar, all interventions resulted in significant reductions in house entry. Table 6 shows the impact of the different interventions was 55.1% for the push-only, 44.4% for the pull-only and 51.1% for the push-pull intervention.

TABLE 6
Mean CDC trap catches of anopheline mosquitoes for the
different interventions, n = 8 for the baseline data
(n = 7 for house 3) and n = 25 for the intervention data.

| Inter- | | Base- | Inter- | Differ- | Differ- | |
|---|---|---|---|---|---|---|
| vention | House | line | vention | ence | ence (%) | Impact |
| Control | 4 | 15.63 | 15.12 | −0.51 | −3.3% | n/a |
| Push | 5 | 13.63 | 5.68 | **−7.95 | −58.3% | −55.1% |
| Pull | 3 | 10.86 | 5.68 | *−5.18 | −47.7% | −44.4% |
| Push-pull | 1 | 21.75 | 9.92 | ***−11.83 | −54.4% | −51.1% |

Asterisks indicate a significant difference-in-differences between the control and the intervention:
*p < 0.05;
**p < 0.01;
***p < 0.001.

Table 7 shows that for An. funestus house entry reductions were 59.5%, 47.4% and 48.9% for the push-only, pull-only and push-pull interventions, respectively.

TABLE 7
Mean catches of Anopheles funestus mosquitoes for the
different interventions, n = 8 for the baseline data
(n = 7 for house 3) and n = 25 for the intervention data.

| Inter- | | Base- | Inter- | Differ- | Differ- | |
|---|---|---|---|---|---|---|
| vention | House | line | vention | ence | ence (%) | Impact |
| Control | 4 | 12.75 | 13.12 | 0.37 | 2.9% | n/a |
| Push | 5 | 10.13 | 4.40 | −5.73 | −56.6% | −59.5% |
| Pull | 3 | 8.57 | 4.76 | −3.81 | −44.5% | −47.4% |
| Push-pull | 1 | 14.00 | 7.56 | −6.44 | −46.0% | −48.9% |

Table 8 shows house entry reductions for An. gambiae s.l. were 32.9%, 29.3% and 39.0% respectively. No further calculations were done for the Culex and Mansonia subgroups, as the low numbers of caught individuals (58 and 9 in total, respectively) would not allow to draw reliable conclusions.

TABLE 8
Mean catches of Anopheles gambiae s.l. mosquitoes for
the different interventions, n = 8 for the baseline
data (n = 7 for house 3) and n = 25 for the intervention data.

| Inter- | | Base- | Inter- | Differ- | Differ- | |
|---|---|---|---|---|---|---|
| vention | House | line | vention | ence | ence (%) | Impact |
| Control | 4 | 2.88 | 2.00 | −0.88 | −30.6% | n/a |
| Push | 5 | 3.50 | 1.28 | −2.22 | −63.4% | −32.9% |
| Pull | 3 | 2.29 | 0.92 | −1.37 | −59.8% | −29.3% |
| Push-pull | 1 | 7.75 | 2.36 | −5.39 | −69.5% | −39.0% |

The MM-X traps placed outdoors in the pull-only and push-pull treatments caught 1,356 mosquitoes (95.6% female, 4.4% male) in total, of which 616 (45.4%) were anophelines and 740 (54.6%) culicines. The anophelines were 52.1% An. funestus, 43.8% An gambiae s.l. and 4.1% other anopheline spp. The mean number of mosquitoes caught outside in the push-pull treatment (29.16, SEM 4.32) was not significantly different from the mean number caught in the pull-only treatment (25.08, SEM 2.54).

### Malaria Transmission Model

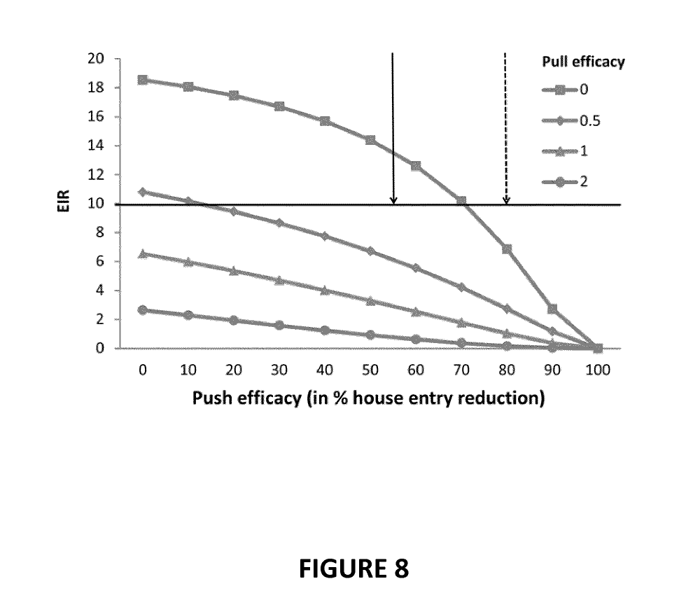

FIG. 8 shows model simulations showing the entomological inoculation rate (EIR) as a function of different levels of push efficacy. Push efficacy is expressed as the percentage of house entry reduction and pull efficacy is expressed as the relative attractiveness of the trap, compared to a human being. In this scenario mosquitoes are fully susceptible to insecticides.

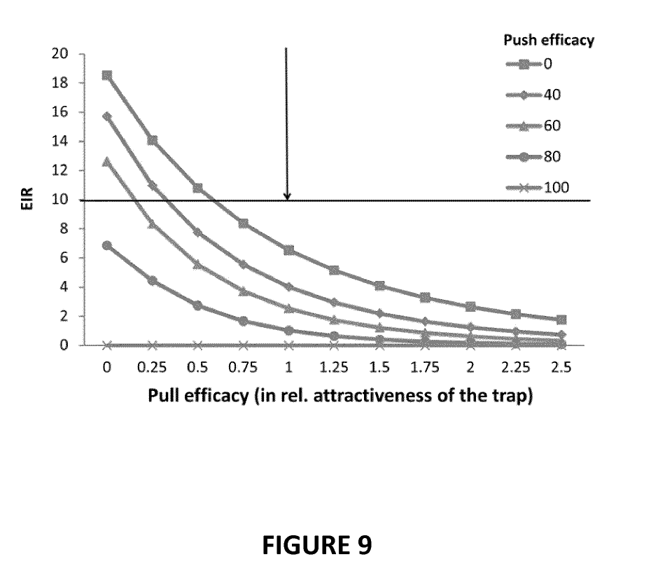

FIG. 9 shows model simulations showing the entomological inoculation rate (EIR) as a function of different levels of pull efficacy. Pull efficacy is expressed as the relative attractiveness of the trap, compared to a human being. Push efficacy is expressed as the percentage of house entry reduction. In this scenario mosquitoes are fully susceptible to insecticides.

Model simulations show the impact of push and/or pull interventions, with various levels of efficacy, on the EIR. An EIR of 10 has been indicated as the threshold value below which malaria ceases to be self-sustaining. Under the given assumptions, both repellent barriers and odour-baited traps result in strong reductions of the EIR. A repellent barrier with a push efficacy of 55% reduction in house entry (solid arrow) combined with an odour-baited trap with a pull efficacy of 0.5 times the attractiveness of a human being, would bring the EIR down below the threshold value. With a repellent barrier that has a push efficacy of 80% reduction in house entry (dotted arrow) the EIR would already be brought down below the threshold value by the action of the repellent alone. With odour-baited traps that have the same attractiveness as a human being, the repellent barrier would not be needed for the EIR to go down below 10. However, in all simulations using both the repellent and the traps has an additional effect compared to using either one intervention alone.

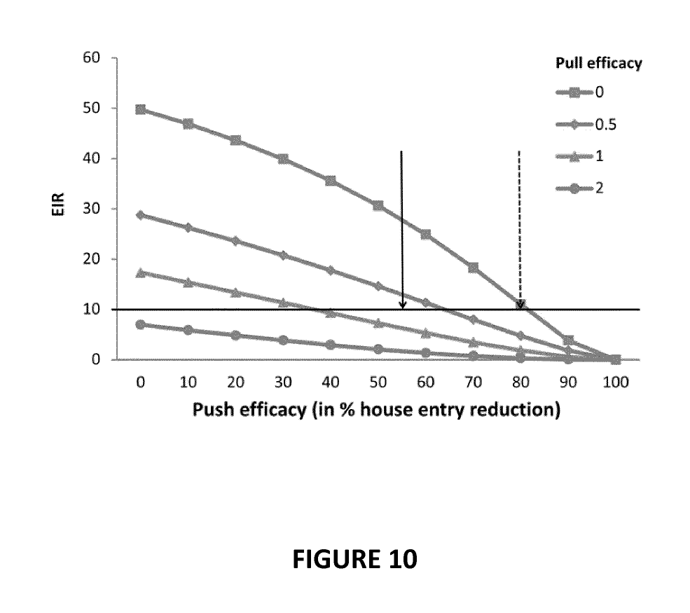

FIG. 10 shows model simulations of a scenario in which mosquitoes are highly resistant against insecticides. Shown is the entomological inoculation rate (EIR) as a function of different levels of push efficacy. Push efficacy is expressed as the percentage of house entry reduction and pull efficacy is expressed as the relative attractiveness of the trap, compared to a human being.

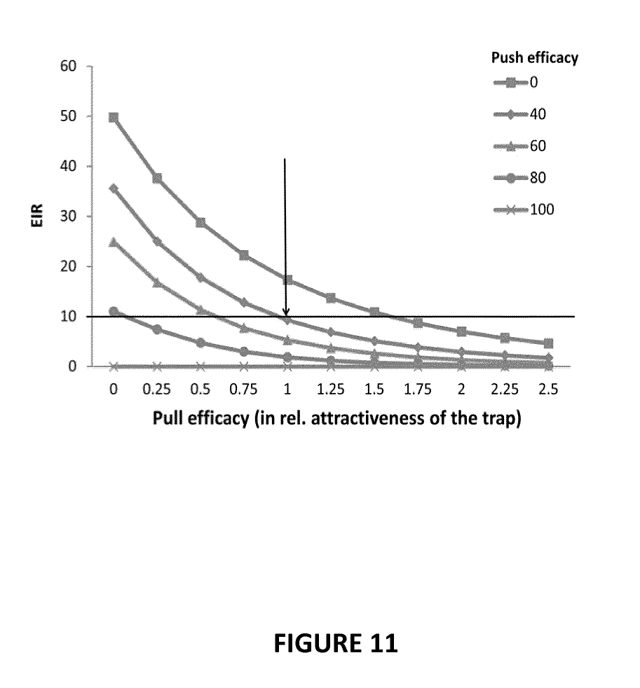

FIG. 11 shows model simulations of a scenario in which mosquitoes are highly resistant against insecticides. Shown is the entomological inoculation rate (EIR) as a function of different levels of pull efficacy. Pull efficacy is expressed as the relative attractiveness of the trap, compared to a human being. Push efficacy is expressed as the percentage of house entry reduction.

In a high-resistance scenario, EIR values were calculated to be much higher (e.g. over 2.5 times higher for the baseline situation) than in the scenario where mosquitoes are assumed to be fully susceptible. A push efficacy of over 80% reduction in house entry (dotted arrow) or odour-baited traps of nearly two times the attractiveness of a human being would be needed to bring the EIR down to below 10 by using either one of the two interventions. However, when combining a repellent barrier with odour-baited traps, a push efficacy of 55% (solid arrow) would still be sufficient to reduce the EIR below the threshold value, when the pull efficacy of the traps would be identical to the attractiveness of a human being.

The behavioural tests in the repellent bioassay showed a consistent repellent effect of the treated fabric, which was maintained for a period of at least six months. Because samples were stored in plastic bags in a refrigerator in between the tests, evaporation of volatiles from the fabric was presumably much lower than under field circumstances. The fabric intended for use in the field study was prepared identically and stored for two months in the same way, thus we may expect it to have been similarly efficient by the time it was applied in the field.

During the field experiment, it was found that even a narrow strip of repellent-treated fabric reduced mosquito house entry by 52.8%. This must have resulted from a ‘barrier’ of repellent, as the fabric did not physically close off the eave, leaving ample space for mosquitoes to fly over as they did in the control treatment with untreated fabric. In the experiments, mosquitoes most likely encountered the fabric before entering the house (which is the reason the fabric is applied in the lower part of the eave, closing off the bottom 10 cm rather than the middle or upper section).

The employment of an attractant-baited trap outside the experimental house reduced mosquito house entry by 43.4%. This suggests that mosquitoes were lured into the trap before they could enter the house. This is an unexpected result, as previous observations indicated that outdoor traps do not directly influence mosquito house entry (Jawara M, Smallegange R C, Jeffries D, Nwakanma D C, Awolola T S, Knols B G J, Takken W, Conway D J (2009) Optimizing odor-baited trap methods for collecting mosquitoes during the malaria season in The Gambia. PLoS One 4: e8167.) However, the positioning of the trap, relative to the location of mosquito breeding sites or resting places may potentially influence the trap's efficacy in luring mosquitoes away from a house before entering. Moreover, the outdoor trap caught 25.08 mosquitoes on average, which is considerably more than the 6.12 individuals caught by the CDC trap indoors during the pull-only intervention or even than the 15.60 individuals that were caught on average in the control house. Although these catches cannot be compared directly, it confirms findings from previous studies showing that attractant-baited traps are a very potent tool to trap away large numbers of mosquitoes.

When the repellent-treated fabric and the attractant-baited trap were combined, mosquito house entry was reduced by 51.6%. This reduction is a bit higher than the reduction achieved by the attractant-baited trap alone, but rather similar to the reduction achieved by the repellent alone. Without wishing to be bound by theory, the inventors find that both components (i.e. the push and the pull) have independent effects. However, in a scenario where coverage of the intervention is much higher than in our experiment, simultaneous employment of the attractant and repellent may still lead to a greater impact. The model simulations show that, in a scenario where each household is covered by the intervention, malaria transmission is strongly reduced by adding either the push or the pull component to existing prevention efforts. Moreover, the combination of push and pull always reduces the EIR further than one of the components alone. Especially in a high insecticide-resistance scenario, it is the combination of the repellent barrier and attractant-baited traps that is able to bring the EIR down below the threshold value.

The required efficacy of the push and the pull components lies within the range of what has experimentally been shown to be feasible. For example, a repellent barrier with an efficacy of 55% (as indicated by the solid arrow in FIGS. 8 and 10) has been found in this study for the house entry of anopheline mosquitoes. Likely, this efficacy could easily be improved by closing off much more of the eave, instead of leaving most of it open (as was done here for experimental purposes). In a previous study in the semi-field, house entry was reduced by 80% (as indicated by the dotted arrow in FIGS. 8 and 10) using only a repellent. Odour baits with an attractiveness similar to that of humans (line/triangles in FIGS. 8 and 10, solid arrow in FIGS. 9 and 11) have already been identified (Okumu F O, Killeen G F, Ogoma S, Biswaro L, Smallegange R C, Mbeyela E, Titus E, Munk C, Ngonyani H, Takken W, Mshinda H, Mukabana W R, Moore S J (2010) Development and field evaluation of a synthetic mosquito lure that is more attractive than humans. PLoS One 5: e8951, Mukabana W R, Mweresa C K, Otieno B, Omusula P, Smallegange R C, Van Loon J J A, Takken W (2012) A novel synthetic odorant blend for trapping of malaria and other African mosquito species. J Chem Ecol. 38: 235-244. Mukabana et al., 2012a) and are currently being deployed in large field trials (Hiscox A., Maire N., Kiche I., Silkey M., Homan T., Oria P., Mweresa C., Otieno B., Ayugi M., Bousema T., Sawa P., Alaii J., Smith T., Leeuwis C., Mukabana W R., Takken W. (2012) The SolarMal Project: innovative mosquito trapping technology for malaria control. Malaria Journal 11: O45.

In the push-pull intervention of our experiment, an average of no less than 29.16 mosquitoes per night were caught in the outdoor trap, compared to 10.32 by the trap indoors. Without wishing to be bound by particular theory, the inventors believe that large-scale employment of traps that catch such high numbers of mosquitoes may have an indirect effect on malaria transmission, in addition to their direct effect as ‘alternative hosts’. While both the repellent barrier and the odour-baited traps reduce the human biting rate, which directly influences EIR, the traps may also have an additional effect by simultaneously reducing the mosquito's lifespan and by depleting mosquito populations to such an extent that transmission of malaria is impeded,

### Push-Pull as a Vector-Control Tool

In the experiments, fabrics treated with delta-undecalactone reduced mosquito house entry. When implemented as a vector-control tool, one would not use narrow strips of fabric that leave open most of the eave for mosquitoes to enter, as was done in this study for experimental purposes. Rather, one would close off all openings as much as possible, to install a physical barrier, besides the semiochemical one. This of course, brings to mind the practise of screening eaves and/or ceilings, which has already proven to be an effective measure against mosquito house entry. However, house screening is difficult in the typical mud-walled houses that make up the majority of houses in the village where this study was conducted, or indeed in many other traditional hand-built houses that are commonly found in the African countryside. The many cracks and uneven edges hinder the full closure of the eave, or other openings, with gauze or netting. The use of a spatial repellent, with a long lasting effect and impregnated on the eave screens would not require to close off each little hole and crack as it would provide a semiochemical barrier as well. Furthermore, net fabric made of cotton is cheap, readily available and allows some degree of air circulation, the main purpose of eaves.

Field experiments employing a repellent to reduce house entry are many, but few report effects of the magnitude observed in this study for a prolonged period of time (i.e. more than a few hours) (see Maia M F & Moore S J (2011) Plant-based insect repellents: a review of their efficacy, development and testing Malaria Journal 10(Suppl 1): S11 and references therein). One category of repellents that do cause very significant reductions in house entry are the volatile pyrethroids. Application of these volatile, or vaporized insecticides resulted in house entry reductions of over 90% in houses with open eaves or similar constructions. However, there are two main objections against the use of insecticides. The first is the development of resistance in the target species. Although to repel mosquitoes is not the same as killing them, and thus may be less prone to the development of resistance, these chemicals are from the same class, the pyrethroids, as those used on bed nets (which are meant to kill) and structurally similar. The second, but no less important, argument against pyrethroid insecticides is the concern about the health effects on humans who are exposed to the chemical for prolonged periods of time. A volatile insecticide, dispensed in or around human dwellings would be inhaled, increasing one's exposure to potentially harmful chemicals. Delta-undecalactone is a natural product that is present in food sources such as edible fruits and dairy products and its odour is generally described as fruity, coconut-like and pleasant. The compound is unlikely to cause any health or environmental effects as are associated with insecticides.

In the system presented here, the push and the pull component operate independently. In other words, mosquitoes that are pushed away from the house do not have a greater chance to be pulled into the trap. This may actually be an advantage, as it would decrease the chance that mosquitoes develop resistance against the repellent, which would surely be stimulated if mosquitoes that are pushed away would have a greater chance of dying in a trap.

In a scenario where coverage of the intervention is high, the greatest benefit can be gained by using both repellent barriers and odour-baited trapping devices to reduce malaria transmission. An advantage of using an odour-baited trap next to a repellent is that mosquitoes are not only repelled from a house, but also actively trapped away from the system. As the odour-bait is a blend that consists of five different compounds, all of which are also present in human skin emanations, it is unlikely that mosquitoes rapidly become insensitive to it.

1. δ-decalactone and/or δ-undecalactone for use as an insect repellent.

2. δ-decalactone and/or δ-undecalactone for the use as claimed in claim 1, wherein the insect is a blood sucking dipteran, e.g. mosquito.

3. δ-decalactone and/or δ-undecalactone for the use as claimed in claim 2, wherein the mosquito is (a) of the genus Anopheles; preferably a mosquito of the species An. gambiae; or (b) of the genus Aedes; preferably a mosquito of the species A. aegypti.

4. δ-decalactone and/or δ-undecalactone for the use as claimed in any preceding claim, wherein the δ-decalactone and/or δ-undecalactone is used in combination, separately, sequentially or simultaneously, with a further insect repellent.

5. δ-decalactone and/or δ-undecalactone for the use as claimed in claim 4, wherein the further insect repellent is selected from 6-methyl-5-hepten-2-one (6MHO), linalool (LNL), N,N-diethyl-meta-toluamide (DEET) and p-Menthane-3,8-diol (PMD).

6. δ-decalactone and/or δ-undecalactone for the use as claimed in any preceding claim, wherein the δ-decalactone and/or δ-undecalactone is used in combination with a spatially separate insect attractant or trap, so as to provide a push-pull insect control.

7. δ-decalactone and/or δ-undecalactone for the use as claimed in any preceding claim, wherein the δ-decalactone and/or δ-undecalactone is present in a liquid formulation; preferably in an organic solvent or oil.

8. δ-decalactone and/or δ-undecalactone for the use as claimed in any of claims 1 to 3, wherein the δ-decalactone and/or δ-undecalactone is in the form of a cream, lotion, ointment or solid and formulated for topical use in a human or animal.

9. A composition comprising δ-decalactone and/or δ-undecalactone in a cream, lotion, ointment, spray, gel or solid vehicle suitable for topical application to a human or animal; preferably wherein the δ-decalactone and/or δ-undecalactone is at a concentration of at least about 1% (w/w).

10. A composition for making articles, fabric, textile, mesh or net comprising δ-decalactone and/or δ-undecalactone in a synthetic resin; preferably wherein the δ-decalactone and/or δ-undecalactone is at a concentration of at least about 1% (w/w).

11. An article or a material coated and/or impregnated with δ-decalactone and/or δ-undecalactone; preferably at least about 1% (w/w) δ-decalactone and/or δ-undecalactone.

12. An article or material as claimed in claim 11, selected from a fabric, textile, mesh or net.

13. Insect repellent apparatus comprising a container containing a composition comprising δ-decalactone and/or δ-undecalactone.

14. An insect repellent apparatus as claimed in claim 13, wherein the container is in fluid connection with an orifice which can be exposed to the air, or a porous surface which can be exposed to the air.

15. An insect repellent apparatus as claimed in claim 14, wherein the container and orifice provide discharge of composition into the surrounding airspace; optionally wherein the container containing the composition is pressurised, e.g. is an aerosol.

16. An insect repellent apparatus as claimed in claim 14, wherein composition evaporates on the porous surface; optionally wherein at least a portion of the porous surface is heated.

17. A kit comprising a first container containing a composition comprising δ-decalactone and/or δ-undecalactone, and an insect attractant, optionally the attractant is included as part of a trap or killer.

18. A kit as claimed in claim 17, wherein the insect attractant is a composition contained in a second container.

19. A push-pull system of insect control comprising insect repellent apparatus of any of claims 13 to 16, and a spatially separate insect attractor, optionally included as part of a trap or killer.

20. A method of controlling insects in an area, comprising releasing δ-decalactone and/or δ-undecalactone into the air at one or more locations in and/or outside of the area.

21. A method as claimed in claim 20, wherein the locations are spaced apart by at least 2 metres, optionally by a distance selected from at least 3 metres apart, at least 4 metres apart, at least 5 metres apart or at least 6 metres apart.

22. A method as claimed in claim 20 or claim 21, further comprising locating one or more insect attractors, traps or killers in and/or outside of the area, the insect attractors, traps or killers being at spatially separate locations from the release of δ-decalactone and/or δ-undecalactone into the air whether in and/or outside of the area.

23. A method as claimed in claim 20 or claim 21 wherein the δ-decalactone and/or δ-undecalactone is released into the air inside the area and the insect attractors, traps or killers are located outside the area.
